(19) United States
(12) Patent Application Publication
(10) Pub. No.: US 2011/0261211 A1
(43) Pub. Date: Oct. 27, 2011

(54) APPARATUS AND METHOD FOR CONSTRUCTING A DIRECTION CONTROL MAP

(75) Inventors: Mark Howard Lee, Ceredigion (GB); Fei Chao, Fujian (CN)

(73) Assignee: ABERTEC LIMITED, Ceredigion (GB)

(21) Appl. No.: 12/741,126

(22) PCT Filed: Nov. 3, 2008
(86) PCT No.: PCT/GB08/03714

§ 371 Date: Jul. 18, 2011

(30) Foreign Application Priority Data
Nov. 2, 2007 (GB) 0721615.3

(51) Int. Cl. H04N 5/232

(52) U.S. Cl. 348/211.4; 348/E05.042

(57) ABSTRACT

Construction of a direction control map for a capture device comprises detecting an image stimulus and redirecting the image capture device such that the stimulus coincides with a reference location on the image.

### PRIORITY CLAIM

The present application is a National Phase entry of PCT Application No. PCT/GB2008/003714, filed Nov. 3, 2008, which claims priority from Great Britain Application Number 0721615.3, filed Nov. 2, 2007, the disclosures of which are hereby incorporated by reference herein in their entirety.

### TECHNICAL FIELD

The invention relates to a method and apparatus for constructing a direction control map, for example, for an automatically directable image capture device such as a motorized camera.

### BACKGROUND ART

Such an approach is known for example for ocular-motor systems comprising a motor driven camera requiring sensory-motor coordination to provide the motor variables that drive the camera to center the image on an image stimulus.

Referring to FIG. 1 and FIG. 2, one known way of calibrating a motorized visual system can be further understood. Referring to FIG. 1 a camera such as a video or a CCD device 100 is automatically movable in two dimensions allowing both panning (Mₚ) and tilting (Mₜ) Referring to FIG. 2 the corresponding image is shown as a Cartesian grid 200 having grid positions 202, 204 etc. Each reference position on the image 200 has a corresponding motor value for pan and tilt, (Mₚ, Mₜ). As a result when an image stimulus appears at that position in the grid the corresponding motor values (Mₚ, Mₜ) are retrieved and the camera is redirected accordingly to bring the image stimulus to a reference point such as the center point X of the image, 206. So, for example, when an image stimulus 208 appears in grid location 204 the corresponding motor values (Mₚ, Mₜ) are retrieved, the values fed to the camera motor and the camera moved such that the image stimulus 208 falls upon the center of the image 206.

According to the conventional approach the motor values (Mₚ, Mₜ) for each location are obtained during a calibration exercise. For example the camera may be moved under operator control to each of the grid positions and the corresponding motor movements recorded and stored against each position. However this means that for a lens, motor or other variable change or potentially in the case of lens aberration complete recalibration will be required in time requiring operator intervention and a potentially long down time.

### SUMMARY OF THE INVENTION

According to one embodiment of the invention, camera-motor coordination uses a redirection information such as a vector when a stimulus is detected. If the camera movement according to the re-direction vector results in the image stimulus coinciding with a reference point on the image then the corresponding redirection information is stored. As a result operator controlled calibration is not required, as randomly or naturally occurring image stimuli can be used to generate redirection information and instead the mapping is learned. The redirection vector can be randomly or pseudo-randomly determined, or can follow a pre-determined search pattern, but is not based on any knowledge of what redirection is required, i.e., is not known to cause the stimulus to coincide with the reference.

According to another embodiment, where redirection information is already stored for at least some of the positions in the image when a new image stimulus is detected, the image capture device is redirected according to redirection information from a nearby image position for which redirection information is already stored. As a result it will be seen that the stimulus image will be moved closer to the reference point after redirection at which point it will either be coincident with the reference point in which case the redirection information is stored against the image stimulus point or the process can be repeated and the sum of the movements stored, allowing the system to “zero in” on the reference point in a reduced number of movements. According to other embodiments, where the stimulus moves through intermediate positions, mappings can be created for these too, and vector combination can be used to derive yet further mappings. According to another embodiment, interpolation can be used to weight and apply the redirection vector attributed to nearby image positions.

### BRIEF DESCRIPTION OF THE DRAWINGS

Embodiments of the invention will now be described, by way of example, with reference to the drawings of which:

FIG. 1 is a schematic diagram of a directable image capture device;

FIG. 2 is a schematic representation of an image;

FIG. 3 is a flow diagram showing at a high level steps implemented according to the method described herein.

FIGS. 4a to 4h show an image stimulus in an image during successive redirection step according to an embodiment of the method described herein;

FIGS. 5a to 5e show an image stimulus during successive steps according to a further embodiment of the method described herein;

FIGS. 6a to 6g show an image stimulus for successive steps according to another embodiment;

FIG. 7 is a flow diagram illustrating at a low level steps implemented according to the method described herein;

FIG. 8 is a schematic diagram illustrating a computer system for implementing the method described herein; and

FIGS. 9a to 9c are schematic diagrams showing population of additional fields using vector combination.

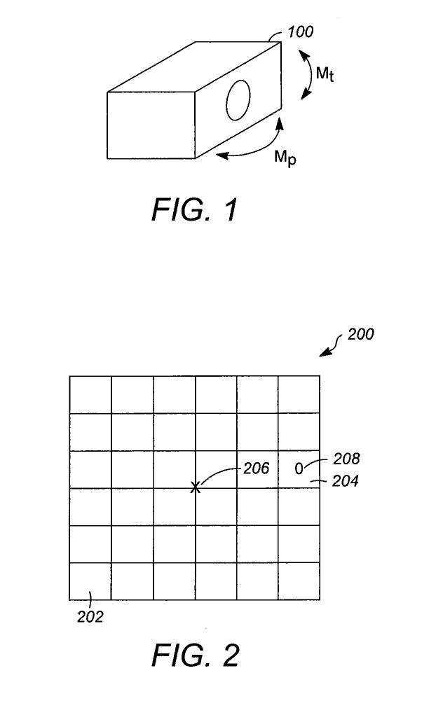

### DETAILED DESCRIPTION

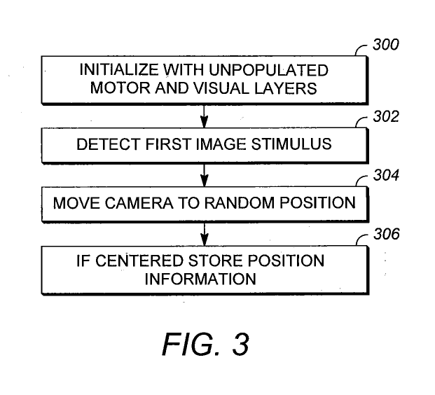

In overview, the approach described herein relates to learning issues involved in the sensory-motor control of a directable image capture device such as a camera or robotic eye. As a result, machine learning or automatic learning of the correspondence between camera motion and fixating on a point in the image captured by the camera is provided. Referring to FIGS. 3, 4 and 5, the method in which the construction of a direction control map—for example a set of values to be fed into a motor driving a camera according to a control scheme in a motor layer to center an image stimulus in an image or visual layer on a reference location such as the center point of the image can be further understood. It will be noted that a polar coordinate system is shown rather than the Cartesian system shown in FIG. 2, but any coordinate system can be adopted.

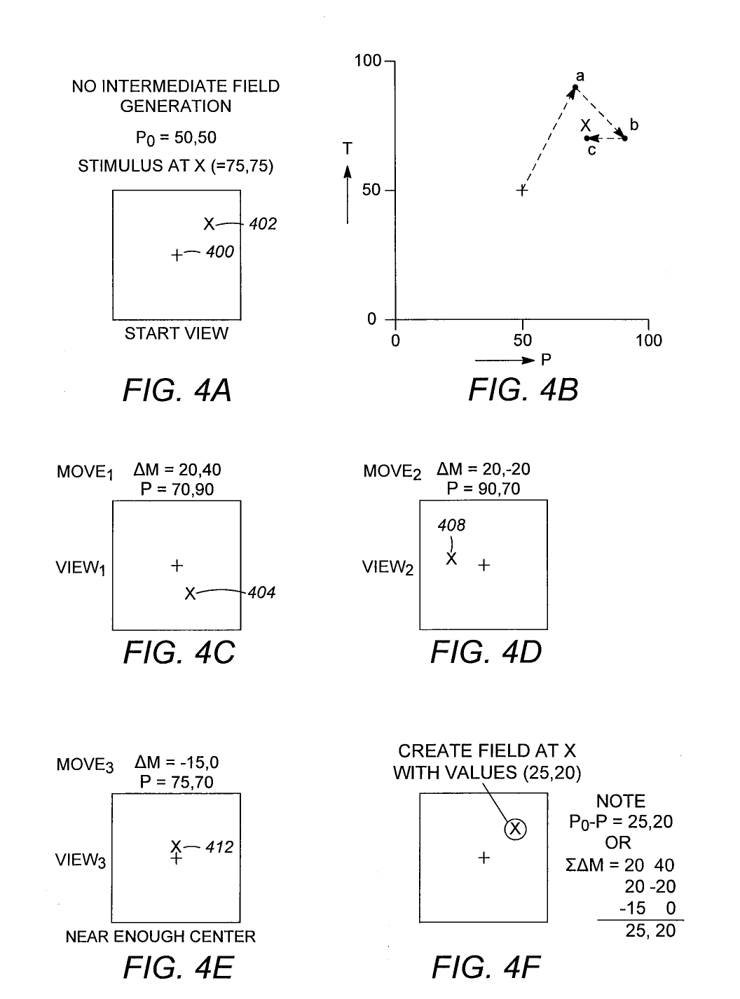

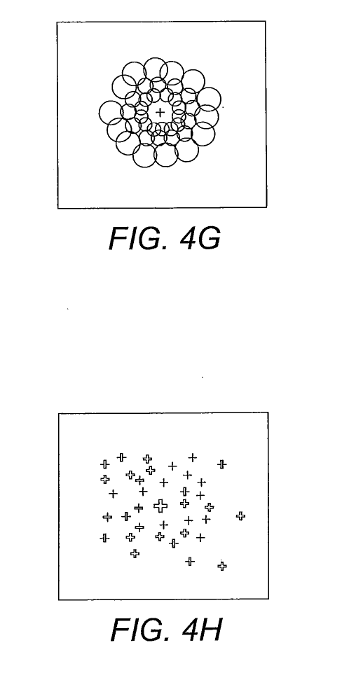

Referring firstly to FIG. 3, at the outset, before learning has commenced, the image layer is unpopulated as shown in FIG. 4a and the control value motor layer is shown in FIG. 4b with pan (P) and tilt (T) values for from 0 to 100, and starting position P=(50, 50) (Po1). The maps are not pre-wired or pre-structured for any specific spatial system.

In the image of FIG. 4a, a reference location comprising a center point or region is shown at 400. Fields comprising areas such as groups of pixels sharing common redirection information are created when new sensory-motor values are to be recorded and the maps become populated according to the patterns of experiential events. Hence the system at this stage does not know how to move the camera to a position (P) to fixate it on a given point and has no information regarding the relationship between camera movement and effect of what is in the image field.

At step 302 a first stimulus image is created. This may be in any manner. For example a light point, object, movement or image or any distinguishable or definable visual feature in the image may be placed or appear in the camera field of view and this may be done under operator control or may rely on random occurrences in the image. In addition the stimulus image may be a point image corresponding to a single pixel in the image or may be of greater dimension in which case, as discussed in more detail below, the center pixel or any other appropriate point within the image stimulus may be selected as a control point. Hence, as can be seen in FIG. 4a, an image stimulus 402 is detected in the image at (75, 75). The system must now learn what motor values will move the camera such that the stimulus is centered.

At step 304 the camera is moved randomly as shown in FIG. 4c, for example according to a randomly determined redirection vector ΔM=(20, 40) providing new camera position a (70, 90) shown in FIG. 4b. Any other movement unrelated to the image stimulus location can alternatively be adopted for example according to a pre-programmed position independent value.

At step 306, if the image stimulus is centered or otherwise coincides with reference location on the image, then the redirection information corresponding to the redirection vector, is stored against the original image stimulus location 402 as shown in FIG. 4b for example by creating a mapping between the values.

According to one approach if, after the first random repositioning of the camera the image stimulus is not centered, then the system simply resets, does not store any values and instead waits for the next image stimulus and attempts to find a mapping once again. As shown however in the embodiment depicted in FIGS. 4d to 4f, additional redirection vectors ΔM=20, −20, P=90, 70 (position b), and ΔM=(−15, 0) P=75, 70 (position c) are adopted until, in FIG. 4e the stimulus is within a tolerance range of the center. Hence a field can be created at the original stimulus position with motor values Po−P=25, 20 or ΣΔM=25, 20, as shown in FIG. 4f and position X in FIG. 4b It will be seen that this can be achieved irrespective of the number of movements of the image stimulus to center it. Thus, if a stimulus is detected in the future at that position, it can be immediately centered using the stored motor movement values.

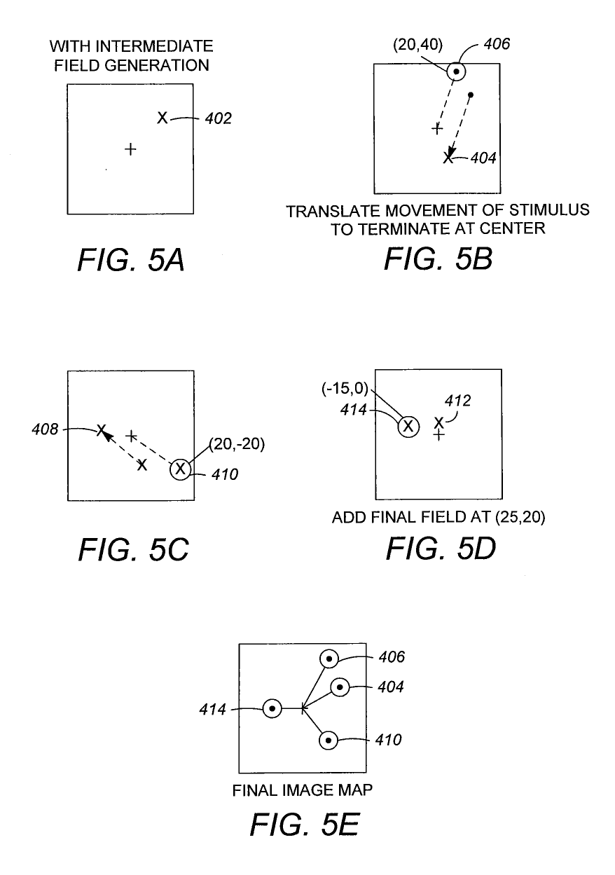

According to this embodiment, as can be seen in FIGS. 5a to 5e, intermediate fields are generated. Accordingly, after the first redirection vector ΔM=20, 40 the stimulus 402 is repositioned at 404 and a corresponding field for a point on the image 406 that would be mapped to the center by the corresponding vector is created with values 20, 40. In other words, the redirection vector is translated so that it ends at the center and a field is created at its other end for which the mapping information is entered.

The manner in which the origin point of the vector can be determined can use any appropriate vector mathematics approach. For example, the angle of the vector can be determined against a predetermined origin angle (for example degrees clockwise from vertical) and the length of the vector determined by simple trigonometry to allow the vector to be translated relative to the center or reference point to establish its start point for positioning of the intermediate field. Because the motor movements corresponding to the movement vector on screen are known, and the reference location is known once centered, the corresponding start point of the vector can be populated as a field.

In FIG. 5c, similarly, the stimulus is mapped by vector AM=(20, −20) to position 408 and a corresponding field is created the point which would be mapped by the corresponding vector to the center. Finally, at FIG. 5d, where the stimulus is moved to position 412 by redirection vector ΔM=(−15, 0), the corresponding field is created at point 414 with redirection values −15, 0. Then, in FIG. 5e, the final image mapping is shown where not only the field exists for the original position, but also for the intermediate positions 406, 410, 414 simply by using the information obtained during the centering exercise. As will be further discussed below, additional features are contemplated. For example, for each intermediate location of the image stimulus, while it is being centered, the corresponding redirection information can be stored.

The image can be treated as multiple regions or fields of overlapping elements such that any image stimulus falling within a given field is assigned the same redirection information. Similarly the center point or reference location can be a point or feature of predetermined dimension. According to a further embodiment described in detail below, once the image redirection mapping is partially populated, redirection information can be found for an image stimulus in a location not yet having a mapping more quickly by centering the image on the nearest neighbor to the image stimulus for which a mapping does exist.

As a result, it will be seen that simply by relying on successive image stimuli being centered and adopting a machine learning approach to finding the redirection information or vector for each point or field in the image, a system that does not require calibration but automatically learns the mappings between image position and motor value can be obtained. Yet further, by assigning common redirection information to fields having a predetermined dimension the resolution can be varied so as to accelerate the process. Yet further, by deriving redirection information for each intermediate position during centring multiple mapping can be created during a single centering operation. Further still, by identifying a near or nearest neighbor point to an image stimulus without an existing mapping and redirecting the image capture device to center the nearest neighbor, the image stimulus can be quickly centered in one or more iterations of this approach. As further image stimuli are detected and mappings created, it will be seen that the population of the redirection information will become quicker and will require fewer iterations.

Turning to the approach in more detail, when populated as shown in FIG. 4g, there is provided a two dimensional map consisting of many elements or fields and the corresponding motor map is shown in FIG. 4h. Although a mapping can be created for every pixel in the image this is clearly date intensive and so according to another embodiment, multiple fields are created comprising a region of pixels showing the same mapping vector. The fields may be of any shape and size distribution and may be contiguous or overlapping elements. These elements represent patches of receptive area in which the values are equivalent.

The system thus has image data as the sensory input and a two degree of freedom motor system for moving the image, in conjunction with the map layers illustrated in FIGS. 4 and 5. In an embodiment, the map uses polar coordinates because polar mapping is the natural relationship between central and peripheral regions on the image. The motor map (FIG. 4b) is in two degrees of freedom (we ignore axial rotation of the camera) and encodes the usual left-right, up-down movements (pan and tilt). As correspondence between fields on different layers are discovered by experience, they become directly linked. That is, when a movement causes an accurate shift of the image field to a periphery stimulus, then the sensory field (giving the stimulus location) is explicitly coupled to the motor field (giving the motor variables that produce the change). By this means, the sensory-motor relations for accurate saccades (i.e. rapid eye-like movements) are discovered and learned.

According to one simple approach adopting the method described herein, an autonomous learning algorithm can be developed to reflect the above learning process as follows: if an object (or other stimulus) occurs in periphery vision, a visual sensor detects the coordinates of the stimulus position. The detected location is then used to access the ocular-motor mapping. If a field that covers the location already exists, the motor values associated with the field are sent to the ocular motor system which then drives the visual sensor to fixate the object; otherwise, a spontaneous movement is produced by the motor system. After each fixation, i.e., when the visual sensor detects that the object is in the central or foveal region, a new field is generated and the movement motor values are saved with respect to this field. This is summarised as pseudo code below:

```
For each session
  If object in peripheral vision at θ, γ
      Access the ocular-motor map
      If a covering field exists
        Use motor values for this field
      Else
        Record the object's position,
        Make a spontaneous motor move
        If the object is within foveal region (reference location)
          Generate a new field,
          Enter the object's location and the associated motor values
        Else
          Iterate a new session
        End if
      End if
  Else
  Do not move
    End if
Iterate a new session
```

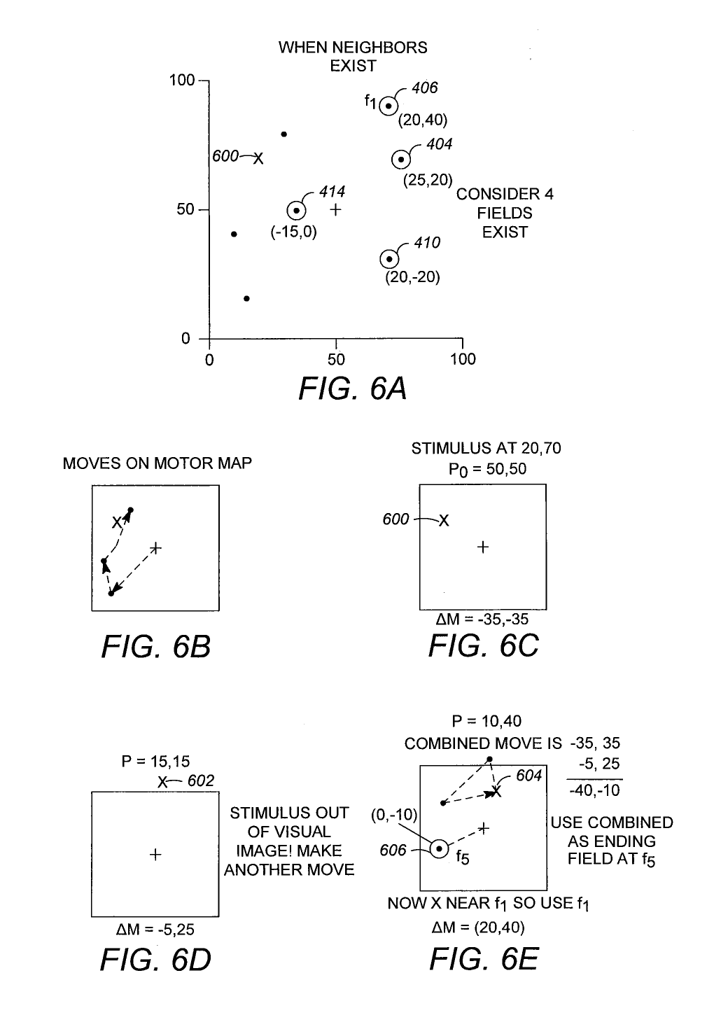

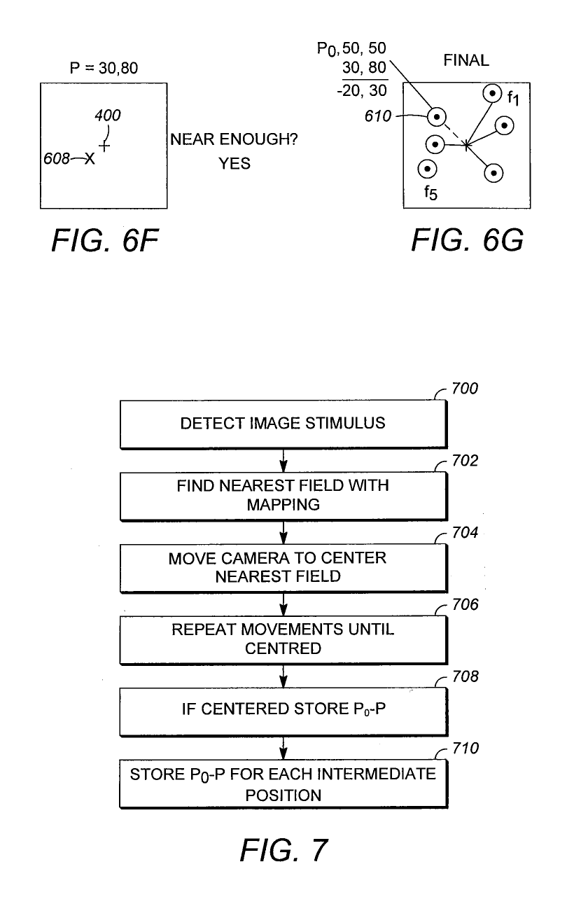

In a further development referred to above, prior experience of the system can be invoked allowing more rapid learning and in particular a reduction in the number of movements required to find the right motor values. This can be understood with reference to FIGS. 6 and 7. According to this approach, where the mappings are partially populated, that is, redirection information is stored for at least some positions or locations in the image, use is made of this existing information when an image stimulus is detected for which no mapping currently exists.

Referring to FIG. 6a, it will be seen that mappings have been created on the motor map for each of the stimulus positions 404, 406, 410, 414 shown in FIG. 5e. The corresponding moves in the image field can be seen in FIG. 6b. When a new stimulus 600 is detected as shown on the image in FIG. 6c and on the motor map in FIG. 6a, for example at image position 20, 70, the system checks whether there is a “near neighbor” depending on some predetermined “nearness” criterion (see below). In the present instance no near neighbor is detected and hence a randomly or otherwise determined redirection vector ΔM=(−35, −35) is applied corresponding to a motor position P=15, 15. In fact, as can be seen at FIG. 6d, in that instance the stimulus is shifted out of the visual image (position 602) and so a further redirection vector ΔM=(−5, 25) is applied to provide a resultant position 604 corresponding to a motor movement P=10, 40. As discussed above, at the same time an additional field is created at 606 at the start point of where, if the resultant vector were applied, the field would be mapped to the center.

At location 604 the repositioned stimulus is close to pre-populated field 406 and hence the corresponding redirection vector ΔM=(20, 40) from that field is applied at FIG. 6e such that the stimulus is repositioned to point 608 which is close enough within a predefined tolerance to be considered as centered in FIG. 6f. As a result the final value is added to the image map in a new field 610. In addition, as discussed above, the fields can be created for the intermediate positions as well as appropriate. Referring to FIG. 7, therefore, at step 700 the image stimulus at X and initial position P=Po is detected. If it is identified that redirection information exists in a corresponding field, then the stimulus is centered. Otherwise, information does not exist for that region of the image (i.e. X is not covered by field) and at step 702, the nearest field for which a mapping does exist is identified. This can be obtained in any appropriate manner. For example, supposing that the ocular-motor map has not yet generated any fields that cover the current stimulus location, let this be (θ, γ). The nearest field to the stimulus can then be selected as an approximation to the target. First an angular tolerance is set to select the fields which have a similar angle with the target field (θ±δ₁). Then, a distance tolerance is set to select the fields nearest to the target field from among the candidate fields in the above set. The distance gap is defined as: γ±δ₂ pixels. The angular parameter is given precedence over distance because, in polar coordinates, the angular coordinate alone is sufficient to determine the trajectory to the origin. From this we obtain a set of fields which fall within the (broad) neighborhood of the stimulus, and the following formula

MIN(√(γ−γ_{χ})²+(θ−θ_{χ})²)

is used to choose the nearest field from this collection, where γ_{χ} and θ_{χ} are the access parameter of the fields in the collection. This is summarised as follows:

```
If no field exist for location θ, γ
  a. For each field, f χ ε fields
    If θ − δ₁<fχ(θ)< θ + δ₁
      Candidates = Candidates U {f _{χ}}
  b. For each field, f χ ε Candidates
          If γ − δ₂ > f _{χ} (γ) or f _{χ} (γ) > γ + δ₂
            Candidates = Candidates − {f _{χ}}
  c. Apply the MIN formula to Candidates
        to find nearest field to θ, γ.
```

Accordingly at step 704, where a neighboring field exists the camera /image is moved to center the nearest neighbor field using the corresponding ΔM value as can be seen in FIG. 6f. It will be seen that this will either bring the new image stimulus closer to the center in which case the process of moving the stimulus position using redirection information is repeated at step 706 or, if it is coincident with a field for which a mapping exists, will center the image stimulus. In either case, the position P is updated as P=P+ΔM and, if centered, the field is populated with (Po−P) at step 708. It will be seen that the more populated the fields become, the more quickly mappings for image stimuli detected in previously unmapped regions of the image can be obtained.

It will be noted that where a stimulus is found to fall in an existing field then of course it is centered using the existing data and the field corresponding to its original position is populated. Conversely when the mappings are relatively unpopulated there is a possibility that there will be no field dependent on the selection criteria used—in this case the process can perform one or more random redirection steps as described above until a nearest neighbor is found.

As discussed above, in a further embodiment, rather than simply storing the redirection information for the first detection location of the image stimulus, for example, by summing vectors of all of the intermediate movements to find the resultant vector, redirection information can also be obtained for each intermediate position the image stimulus occupies in the image during the iteration described above. This embodiment recognises that a new field cannot be generated until the camera has fixated an object at that location, and this process typically takes a long time because most spontaneous moves will not result in a target fixation. However, there is a change in the location of stimulus in the image after each movement. A vector can be produced from this change by where Postion_{old} denotes the object position before movement and Position_{new} the object position after. This vector represents a movement shift of the image produced by the current motor values to allow access to a field in the image layer together with its corresponding motor values on the motor layer. In so doing, a new field can be generated after each spontaneous movement.

Usually, during learning, many spontaneous movements will be needed until a fixation is achieved and by using the movement vector idea each fixation can generate many vectors. The current vector will be a sum of the previous vectors, thus:

Vectorₛᵤₘ=ΣVectorᵢ

And the corresponding motor values can also be produced by summation:

M_{sum(p,t)}=ΣM_{i(p,t)}

This is an incremental and cumulative system, in that the resultant vectors can be built up over a series of actions by a simple recurrence relation:

Vectorₛᵤₘ(t+1)=Vectorₛᵤₘ(t)+Vectorᵢ(t+1)

Referring, therefore, to FIG. 7 once again at step 710 the redirection information is saved for each intermediate position on the image. For example, referring to FIG. 6c, if redirection information did exist for the position occupied by the image stimulus 606 then this could be derived and stored as well according to the algorithm described above.

```
FOR each session
If target, x, in peripheral vision at (theta, gamma)
  access the ocular-motor map
  IF covering field exists, fₓ
      use motor values for this field = M(fₓ), EXIT FOR
  ELSE
    LOOP
    Perform Neighboring fields test,
    IF neighboring field, fₙ found,
      make move using M(fₙ), to location y
    ELSE
      make a spontaneous motor move, to location y
    END IF
    IF point y is within foveal region (centered)
      Generate a new field, fₓ for the target point x,
      Using (theta, gamma) and
      Enter the associated motor values.
        EXIT LOOP
      ELSE
      IF a covering field for y exists, f_{y}
        Use motor values for this field = M(f_{y}), EXIT LOOP
      ELSE y is not covered by a field,
        Create new field f_{y}, and enter motor data
        GOTO LOOP
      END IF
    END IF
    END LOOP
  END IF
ELSE
Do not move
END IF
Iterate a new session
```

As indicated above, mappings can be created for each pixel or point location on the field. In order to accelerate the mapping process and reduce the data storage considerations, however, instead fields containing multiple pixels can be adopted. The field density can be higher in the central areas than the periphery, for example, by allowing the radius of central fields to be smaller than those on the periphery; a simple generation rule allows field radius to be proportional to distance from center. The motor coordinate system is simply Cartesian, as each motor is independent and orthogonal, and so the motor map simply stores values.

Similarly it is recognised that the image stimulus may be a point coincident with a single pixel on the image or may be an object covering multiple pixels or fields. In the latter case the image stimulus may be centered by centering its center pixel according to any appropriate approach. Similarly the field size can be decreased after initial learning is complete and the first mapping is obtained, such that a low—resolution map is obtained quickly and a higher resolution map can be obtained in run-time as required. It will further be noted, of course, that any appropriate distribution of field site and indeed any appropriate field shape or range of shapes can be adopted. It will also be noted that the stimulus can be of any appropriate type and detected accordingly, for example the color of a laser pointer spot, a flashing highlight or indeed coordinate of a selected pixel input directly for example from a key board or from a touch screen that covers the image or any other feature that can be detected.

Similarly the manner in which it can be detected that the image stimulus has entered the reference location can be any appropriate approach such as image processing to detect when it enters a circular center region. The time to complete learning of the map is inversely proportional to the field sizes given even coverage of stimuli. Fine resolution is possible but would require many small fields and in practice the resolution required is determined by the degree of error allowed in centering, that is, the size of the center region or reference location and processing considerations.

Approaches described herein require a level of linearity in the motor map in order to be optimised, for example based on the assumption that a redirection vector applied upon detection of a stimulus will cause the same shift elsewhere in the image irrespective of where the stimulus is detected. However it will further be noted that motor values can be linearized using an intermediate map which can also be created in a learning phase.

In cases where there is extreme lens non-linearity then it will be seen that the resultant movement to shift a stimulus to the center as a sum of the individual movements required to shift it will be entirely accurate but that intermediate fields may be affected by the lack of linearity. In this case just the initial stimulus position can be populated and intermediate fields do not need to be populated in such an instance.

It will further be seen that, for linear or generally linear systems at least, yet further intermediate field positions can be obtained using vector mathematics. Referring to FIG. 9 where, in order to center the stimulus it is moved by redirection vector sa, 900, ab, 902, bc, 904 and cd, 906 then, as discussed above and shown in FIG. 9b, fields can be populated for each of the corresponding positions as shown in FIG. 9b at respective positions 908, 910, 912, 914.

However it will be seen from FIG. 9a that in addition by vector addition, a further vector from starting point 5 to point b can be derived by the sum of vectors sa+sb. Accordingly as discussed above, the corresponding field can be populated at the starting point of this vector translated to directed to the center of the image. As shown in FIG. 9c, therefore, information can be obtained for example for vectors sb, 916, sc, 918 as well as vectors such as vector bd 920 and so forth. In fact for n moves the number of populatable fields is n (n+1)/2.

According to yet a further embodiment, in generally linear arrangements it is possible to use interpolation to obtain an improved estimate of a starting redirection vector from neighbor fields to center a stimulus point. Where, for example, a stimulus point is near two already populated fields, than instead of simply taking the motor values from the nearest field and shifting the camera accordingly, a redirection vendor can be applied as a weighted average of the redirection vectors from two or more neighboring fields, weighting being related to the distance of the stimulus point from the respective fields. For example, a normalized set of weighting factors can be applied proportional to the respective distances of the nearby fields relied on.

In operation the approach can be implemented in a range of different applications. For example, in the case of operator control security cameras, a static surveillance camera could detect, for example, movement and center the image on the area of most movement alerting an operator. By being sensitive to movement it would automatically follow the source and keep it central. In the case of non-operated systems improved quality image and storage could be obtained by moving the camera to points of interest such as movements allowing the camera to center on any such detected movement allowing improved quality recorded footage and the possibility of linking to alarms or surveillance centers.

In a search application, changes or movements can be detected by a search camera allowing the camera to automatically center on an area of interest allowing an operative to decide whether it requires attention or not. This can be of benefit for example where an image remains unchanged for long periods of time.

Systems can be yet further enhanced if definitions are provided for the specific image stimuli being monitored such as a color, type of movement, type of shape and so forth. For example, the stimulus could be a red dot allowing tracking of a laser pointer which could be of use in lectures and video conferencing. In such a case, if the central area or reference location is large enough or of low enough resolution then tremors and jitters from the user will not be followed. Similarly this can be used as an aiming device allowing the camera to be aimed at a dot causing any mechanism attached thereto to be similarly directed for example a hose, an x-ray device, particle accelerator, search lights, infrared torch and so forth. Yet a further possibility is providing a motorized web camera such that the web camera can be moved to keep an object of interest in the center of the image without requiring any prior knowledge of the camera for use in video conferencing, messaging or computer games for example.

A camera fitted with a variable zoom lens can provide mapping for a series of settings of the zoom either by an automated approach when the zoom is motorized or by user selection of a map for a zoom setting. In yet a further approach a mobile camera on the end of an endoscope can allow finer control of the image during medical procedures for example by centering on a formation of interest for a photograph or intervention without requiring mechanical repositioning of the endoscope.

It will further be seen that the system can be used in reverse. Where movement of the object of interest is controlled, for example, by motors then the system can move the object to keep it in the center of the image no matter where the camera is pointing. Referring for example to FIG. 6b, where the camera is fixed and the object 606 is detected in field 604, then the corresponding redirection information for field 604 can be fed to the motors controlling the object to shift the object on to the center point 600. This can be of benefit in controlling robotic devices or gantries.

In yet a further application, if a recording facility is available (as in typical cam-corders etc.) then various different applications are possible. For example, considering a configuration with fixed camera and moveable objects of interest, a desired movement or set of movements can now be learned. Having set the device to record mode, an operator or other agent moves the object in a desired movement pattern, and plays the recording back to the learning system. The location of the object in the visual image is made to be the reference point (or “center”) of the system and so the movement pattern is learned, even over a long sequence of movements. The recordings become templates for desired movement patterns and so the system can use recordings from other sources or systems. In this way the system could imitate or learn from another system.

When a stimulus point is covered by two or more overlapping fields, there are several options for selecting motor values. According to one option, the system uses the closest field, as defined by geometric or vector distance. Alternatively the system can use a function which biases towards the outer fields—this will give more undershoot than overshoot in the resulting redirections or saccades. Alternatively still, the system can use other functions to give bias for high or low aim, or in the direction away from the previous most recent stimulus, or any other bias that may be beneficial. In all cases different selection functions will allow a wide range of bias and subtly different but useful behaviors.

The approach as described above can be implemented in any appropriate manner. For example a motorized camera system can be provided in conjunction with a motor sub-system and two software vision sensors. The motor system is implemented by a motorized pan-and-tilt device and the sensor system by video camera and associated image processing software of any appropriate type.

The pan-and-tilt device provides two degrees of freedom: the pan motor can drive the video camera to rotate about a vertical axis, giving left-right movement to the image, and the tilt motor can drive the camera to rotate about a horizontal axis, giving up-down movement. Combined movements of pan and tilt motors cause motion along an oblique axis. The Pan/tilt device can effectively execute saccade type actions based on supplied motor values from the learning algorithm. Each motor is independent and has a value (Mₚ for Pan and Mₜ for Tilt) which represents the relative distance to be moved in each degree-of-freedom.

The sensor sub-system consists of two sensors: a periphery sensor and a center or foveal sensor. The periphery sensor detects new objects or object changes in the visual periphery area and also the positions of any such changes (encoded by polar coordinates). The center sensor detects whether any objects are in the central (foveal) region of the visual field. In an embodiment, the camera capture rate is one frame per second however faster rate are of course possible, for example video frame rates. Each object is represented by a group of pixels flocking together in the captured image. The position of the central pixel among these pixels is used as the position of that object. The image processing program compares the currently captured image against the stored previous image. If the number or the position of any central pixels within these two images differs, the program regards these differences as changes in the relevant objects, and encodes the positions of both previous and current central pixels of those changed objects in polar coordinates. Note that an object “change” here signals either of the following three situations, (i) an object is moved to a new location in the environment; (ii) an object is removed from the environment; and (iii) a new object is placed in the environment. In an embodiment a circular area, of radius 20 pixels, in the center of the image is defined to be the foveal region. If the central pixel of an object is in this central area, it is considered that the object is fixated; otherwise the object is not fixated.

Once the object is fixated the mapping is created in any appropriate manner. For example the fields in the sensory (image) layer can be plotted in polar coordinates and marked by numeric labels which keep correspondence with the motor fields. If there are changes or problems, e.g. if a camera lens is changed as in a microscope say, the algorithm can be restarted and a new map learned. Maps can be easily stored in files and so a map could be stored for each lens, thus allowing a switch to another map instead or relearning. This means that imperfect or changing lenses/video systems, imperfect motor systems, are no barrier to learning the relationship.

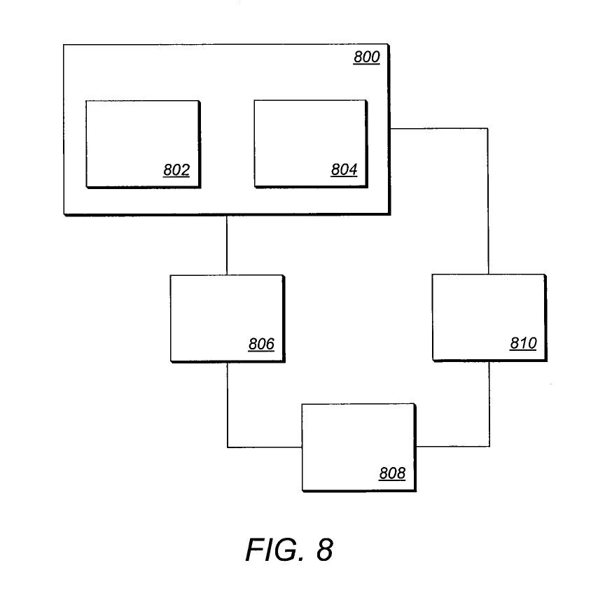

Referring to FIG. 8 it will be appreciated that the approach as described above can be controlled by a computer system for example a personal computer of a type well known to the skilled reader

Accordingly the system comprises a computer designated generally 800 including memory 802 and a processor 804. The computer includes or is connected to an image processing module 806 which receives signals from a camera or other image capture device 808. The camera 808 is controlled to move under the control of a motor module 810 which can be integral or separate from the camera and steps or otherwise moves to predetermined pan and tilt values under the control of the computer 800. Accordingly, in operation, when an image stimulus occurs at the image capture device 808, this is detected by the image processor module 806 and reported to the processor 804. The computer implements the approach as described above to either instruct the motor module 810 to move the image capture device 808 randomly or to relocate it according to redirection information stored for the image stimulus location or its nearest neighbor. The camera is then moved under the control of the motor module 810 until centering is achieved and the corresponding redirection information for any previously unmapped image stimulus location is stored against the location on the image in memory 802.

According to the approach, a simple automatic learning process is provided with out requiring calibration of the device. In particular, it is found that rapid learning is achieved according to the approach as described herein. Once some initial population has taken place it is found that movements using nearest neighbor fields increases sharply and then declines and that direct accurate movements using the correct corresponding fields has an extremely fast rate of increase until only this type of movement exists as the rate of field creation drops. Hence the system is fast, incremental and cumulative in its learning providing a range of desirable characteristics for real-time autonomous agents.

The system can learn both linear and non-linear relationships including any monotonic relation between distance of the image and motor movement and can learn most quickly when stimuli locations are not repeated and have an even distribution. Yet further learning can take place during use—some little used part of the map may not be learned at all during early stages but can be incorporated automatically when required. Yet further selectable resolution is obtained by varying the field size, distribution or shape as appropriate. Yet further no prior knowledge of the image or motor system is required and relearning of the map is possible at any time.

It will be recognised that various aspects of the embodiments described above can be interchanged and juxtaposed as appropriate. Any form of image capture or other imaging or imaging dependent device can be adopted and any means of identifying regions of the image field similarly can be used. Similarly any means of moving and controlling the device can be implemented according to any required coordinate or other system. Although a simple two-dimensional mapping is discussed herein, additional dimensions can be added. For example stereoscopic vision can be implemented or a depth dimension otherwise obtained. In addition to pan and tilt motion, axial rotation or movement in the Z direction may be implemented for the imaging device as well as more complex zoom approaches as described above. Any appropriate field of view, shape, coordinate system, lens, sub-field, shape distribution or dimension and any appropriate positioning, shape or resolution for the reference point can be adopted. Although discussion is made principally of imaging in the visual spectrum of course any image detected in any manner can be accommodated by the approach as described herein. For example a tactile or touch-based approach can be adopted for detecting and centering stimuli, for example, of the type known from atomic force microscopes (AFM) or an artificial skin based on an array of sensing patches allowing movement of the supporting structure such that a touched point is moved to a central reference location. Any appropriate stimulus can be used to teach the system, for example a “test card” or predetermined image containing multiple stimuli can be applied to drive the learning process.

Yet further if there is a change in, for example, a physical parameter of this system such as a lens so that existing redirection information in populated fields no longer centers a stimulus falling within that field then the system can simply re-learn and re-populate the redirection information with replacement information in the manner as described above. This may be detected, for example by noting that a stimulus falling in a populated field and redirected according to the corresponding redirection is not centered, in which case a re-learning algorithm can be commenced following new procedures discussed above to provide replacement information for that field. Of course this can be extended to all fields and all intermediate fields during the re-learning process as appropriate.

It will be seen that alternative functionalities can be implemented using the invention described herein. One such implementation is in the field of camera to camera tracking. This approach is useful for example, where a field of view is shared by two or more cameras or other imaging devices which may have partially or fully overlapping common zones of field of view. For example this may be used in a closed circuit (CCTV) implementation. Currently the use of CCTV to track a subject or other stimulus from one camera to the next requires human intervention which can be costly and complex.

According to the approaches described herein the method of constructing a direction control map can comprise incorporating a “shared” image map that will allow communication between multiple cameras. For example in the case of two cameras each camera will have its own map and there will be a third shared image map, the maps being populated as described herein. This will allow detection of a moving object stimulus from a scene, centering of the object in the field of view and tracking the object using a first or primary camera followed by a secondary and potentially further cameras until out of range. Information from the first camera can be used to position the second camera to pick up the subject before it leaves the first camera's field of view by using the shared map.

Detection of stimulus appearing at the edge of the lens will be permitted and in addition in all of the embodiments described herein, one or more moving stimuli from a single field of view containing multiple similar stimuli can be detected, centered and tracked.

As a result, a stimulus can be tracked by a sequence of cameras without human intervention allowing a more automated and integrated CCTV or other monitoring system.

The approach can be used in range of applications including CCTV surveillance systems and other object tracking systems.

1. A method of constructing a direction control map for an automatically directable image capture device, comprising detecting an image stimulus at a stimulus position in a captured image, redirecting the image capture device according to redirection information and storing redirection information corresponding to said stimulus position if, following said redirection, said stimulus coincides with a reference location on the image, in which the redirection information is not known, prior to said redirection to cause the stimulus to coincide with the reference location.

2. A method as claimed in claim 1 further comprising repeating redirection of said image capture device to one or more intermediate positions until said stimulus coincides with said reference location.

3. A method as claimed in claim 2 further comprising storing redirection information for the stimulus position as the resultant of the multiple redirections.

4. A method as claimed in claim 2 further comprising storing redirection information for at least one stimulus position corresponding to an intermediate position.

5. A method as claimed in claim 1 in which the stimulus position comprises a stimulus position region.

6. (canceled)

7. (canceled)

8. (canceled)

9. A method as claimed in claim 1 in which the reference location comprises a reference region.

10. A method as claimed in claim 1 in which, where redirection information is stored for at least some positions in the image, the method comprises identifying a neighbor position to a stimulus position for which redirection information is stored and redirecting the image capture device according to said redirection information.

11. A method as claimed in claim 10 in which the redirection information is stored for the stimulus position if, following said redirection, said stimulus coincides with the reference location on the image.

12. A method as claimed in claim 10 or 11 in which, following redirection, a new neighbor position is identified and the steps repeated.

13. A method as claimed in claim 1 in which the redirection information is stored as a mapping from a position in an image to a corresponding movement value in a motor field.

14. A method as claimed in claim 1 further comprising detecting an image stimulus at a position in relation to which redirection information is stored and redirecting the image capture device according to the redirection information.

15. (canceled)

16. (canceled)

17. (canceled)

18. A method as claimed in claim 1 in which the redirection vector comprises a randomly determined redirection vector.

19. A method as claimed in claim 1 in which the redirection information comprises a predetermined redirection vector.

20. A method as claimed in claim 1 in which the redirection information comprises a redirection vector and in which, where the redirection vector moves the stimulus position to an intermediate position, redirection information is stored at an image position which would be rendered coincident with the reference location by said redirection vector.

21. A method as claimed in claim 1 in which the redirection information comprises a redirection vector and in which redirection vectors are stored for image positions corresponding to multiple intermediate positions as well as for image positions corresponding to redirection vector combinations.

22. A method as claimed claim 10 in which, if a stimulus has a plurality of neighbor positions then redirection information is derived as a function of the redirection information from at least two of said neighbor positions.

23. A method as claimed in claim 1 in which, if following said redirection said stimulus falls outside an image capture region, a further redirection is applied until the stimulus falls within the image capture region.

24. (canceled)

25. (canceled)

26. A method of constructing a direction control map for an automatically directable image capture device, comprising detecting an image stimulus at a stimulus position in a captured image in which, where redirection information is stored for at least some positions in the image, the method comprises identifying a neighbor position to the stimulus position for which redirection information is stored and redirecting the image capture device according to said redirection information.

27. A method as claimed in claim 26 in which, if a stimulus has a plurality of neighbor positions then redirection information is derived as a function of the redirection information from at least two of said neighbor positions.

28. A method of constructing a direction control map for an automatically detectable stimulus capture device comprising detecting a stimulus at a stimulus position, redirecting the capture device according to randomly determined redirection information and storing said redirection information if, following said redirection said stimulus coincides with a reference location on, in which the redirection information is not known, prior to said redirection, to cause the stimulus to coincide with the reference location.

29. (canceled)

30. (canceled)

31. (canceled)

32. (canceled)

33. (canceled)

34. (canceled)

35. (canceled)

36. (canceled)

37. (canceled)
